(19) United States
(12) Patent Application Publication
(10) Pub. No.: US 2019/0172400 A1
(43) Pub. Date: Jun. 6, 2019

(54) DISPLAY DEVICE

(71) Applicant: SHARP KABUSHIKI KAISHA, SAKAI CITY (JP)

(72) Inventors: HARUYOSHI KOBAYASHI, Sakai City (JP); KENJI HORIUCHI, Sakai City (JP)

(21) Appl. No.: 16/211,026

(22) Filed: Dec. 5, 2018

(30) Foreign Application Priority Data
Dec. 5, 2017 (JP) 2017-233271

(51) Int. Cl. G09G 3/34; F21V 8/00

(52) U.S. Cl. CPC G09G 3/342; G09G 3/36; G09G 2320/0233; G02B 6/0068

(57) ABSTRACT

A display includes light sources, a light guide plate, a display panel, a light source controller, and a display controller. The light guide plate has a light input surface and a light output surface. The display panel overlaps the light output surface and is configured to display an image by using light from the light output surface. The light source controller is configured to switch between a first lighting mode and a second lighting mode. The first lighting mode allows the light sources to be turned on. The second lighting mode allows at least one of the light sources to be turned on and another one to be turned off. The display controller is configured to provide a black display in an end portion of a display area of the display panel adjacent to the light sources in the second lighting mode.

### CROSS REFERENCE TO RELATED APPLICATION

This application claims priority from Japanese Patent Application No. 2017-233271 filed on Dec. 5, 2017. The entire contents of the priority application are incorporated herein by reference.

### TECHNICAL FIELD

The technology described herein relates to a display device.

### BACKGROUND

An example of a known display device is described in Japanese Unexamined Patent Application Publication No. 2005-071610. The display device disclosed in the publication includes a lighting device. The lighting device includes light sources and a light guide plate. Light emitted by the light sources to the light guide plate travels through the light guide plate and exits the light guide plate through the light output surface toward a liquid crystal panel.

### SUMMARY

In recent years, a display device has been required to have a larger screen and to provide higher-definition images. A display device having a larger screen requires a lighting device to apply light over a larger area, increasing the power consumption of the lighting device. Furthermore, the wiring lines increase in the density for the higher definition, reducing the light transmittance of the display panel. This requires the lighting device to emit light having higher brightness, increasing the power consumption of the lighting device. In view of the above, a lighting device that consumes less power is required.

The technology described herein was made in view of the above circumstances. An object is to provide a display device including a lighting device that consumes less power.

To solve the above-described problems, a display device includes light sources spaced apart from each other, a light guide plate, a display panel, a light source controller, and a display controller. The light guide plate has a light input surface that faces the light sources to receive light from the light sources and a light output surface through which the light exits. The light input surface and the light output surface are, respectively, a side surface and a plate surface of the light guide plate. The display panel overlaps the light output surface and is configured to display an image by using light from the light output surface. The light source controller is configured to switch between a first lighting mode and a second lighting mode. The first lighting mode allows the light sources to be turned on. The second lighting mode allows at least one of the light sources to be turned on and another one of the light sources to be turned off. The display controller is configured to provide a black display in an end portion of a display area of the display panel adjacent to the light sources in the second lighting mode.

The second lighting mode, which allows the smaller number of light sources to be turned on than the first lighting mode, consumes less power than the first lighting mode. However, when only the at least one of the light sources is turned on, the light output surface of the light guide plate is relatively dark at the portions corresponding to the light sources that are not turned on, resulting in uneven brightness. Since the light radiates from the light source, the uneven brightness is likely to be seen in the display area at a portion close to the light sources. To solve the problem, the display controller provides a black display in the display area of the display panel over at least an end portion adjacent to the light sources when the light sources are in the second lighting mode. This reduces the power consumption and the uneven brightness in the light output surface, which is caused when only the at least one of the light sources is turned on.

According to the technology described herein, the power consumption is reduced.

### BRIEF DESCRIPTION OF THE DRAWINGS

FIG. 1 is an exploded perspective view illustrating a liquid crystal display device according to a first embodiment.

FIG. 2 is a cross-sectional view taken along a long side of the liquid crystal display device.

FIG. 3 is a block diagram indicating an electrical configuration of the liquid crystal display device.

FIG. 4 is a plan view illustrating the liquid crystal display device in the first lighting mode.

FIG. 5 is a plan view indicating a brightness distribution in a display area of the liquid crystal display device in the second lighting mode.

FIG. 6 is a plan view illustrating an example of an image displayed in the display area of the liquid crystal display device in the second lighting mode.

FIG. 7 is a plan view illustrating another example of an image displayed in the display area of the liquid crystal display device in the second lighting mode.

### DETAILED DESCRIPTION

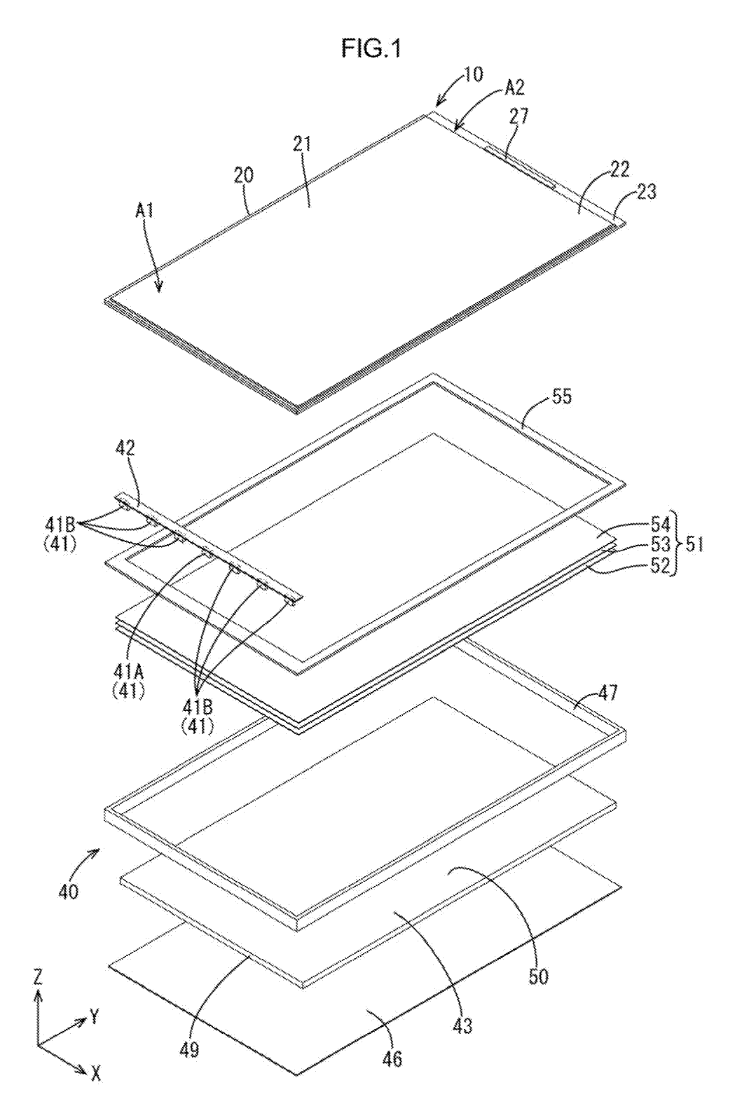

A first embodiment is described with reference to FIGS. 1 to 7. In this embodiment, a liquid crystal display device 10 is described as an example of the display device. As illustrated in FIG. 1, the liquid crystal display device 10 has a vertically long rectangular overall shape. The liquid crystal display device 10 includes a liquid crystal panel 20 (display panel) having a display surface 21 on which an image is displayed and a backlight device 40 (lighting device) that applies light for displaying to the liquid crystal panel 20. The liquid crystal display device 10 according to the embodiment is used in a mobile information terminal, such as a smartphone. Thus, the liquid crystal panel 20 included in the liquid crystal display device 10 has a screen size categorized as a small size in general (a few inches, for example).

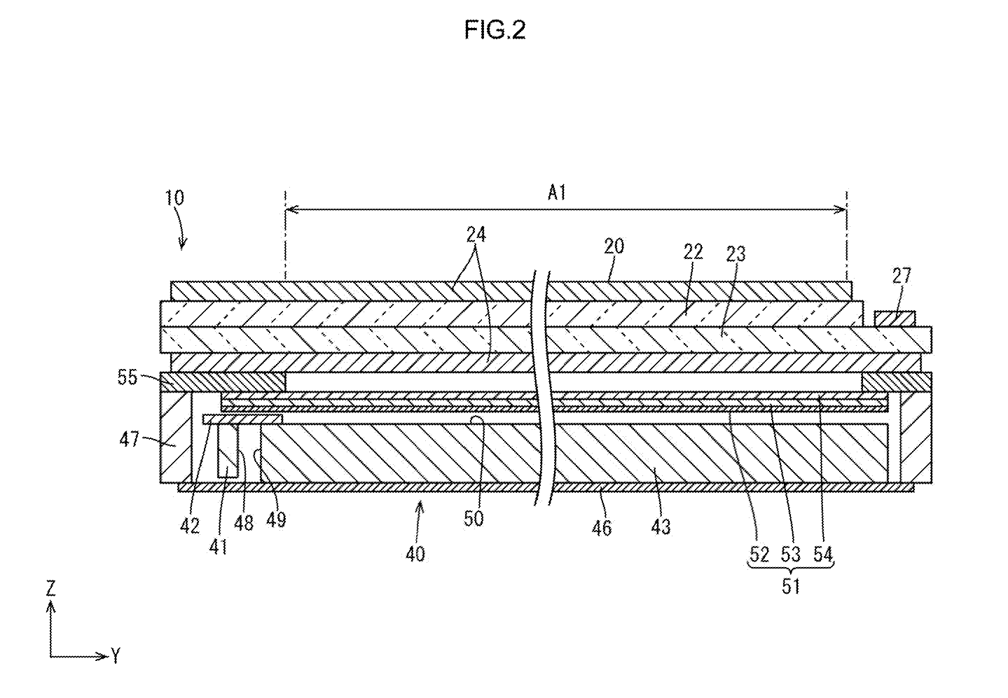

The liquid crystal panel 20 includes two substantially transparent substrates 22 and 23 bonded together with a predetermined gap therebetween. Liquid crystals (not illustrated) are sealed between the substrates 22 and 23. One of the substrates 22 and 23 on the rear side is the array substrate 23. The array substrate 23 has switching devices connected to source lines and gate lines, which are disposed perpendicular to each other, pixel electrodes connected to the switching devices, and an alignment film (none of them are illustrated), for example, thereon. The liquid crystal panel 20 has a display area A1 on which an image is displayed and a non-display area A2 on which an image is not displayed. The non-display area A2 has a frame-like shape and surrounds the display area A1. As illustrated in FIG. 2, front and rear polarizing plates 24 are attached to the outer surfaces of the substrates 22 and 23. The CF substrate 22 has a color filter, a counter electrode, and an alignment film (none of them are illustrated), for example, thereon. One end portion of the array substrate 23 protrudes outwardly from the CF substrate 22 in the long-side direction. An LCD controller 27 that controls the liquid crystal panel 20 is mounted on the protruded portion, for example.

Next, the backlight device 40 is described. As illustrated in FIG. 1, the backlight device 40 is disposed on the rear side of the liquid crystal panel 20 and includes light emitting diodes (LEDs) 41, an LED board 42 on which the LEDs 41 are mounted, a light guide plate 43 that guides the light from the LEDs 41, an optical sheet 51 on the front side of the light guide plate 43, and a light reflection sheet 46 on the rear side of the light guide plate 43, and a frame-shaped frame 47 surrounding the LEDs 41, the light guide plate 43, and the optical sheet 51. The backlight device 40 according to the embodiment is an edge-light type backlight device in which the light from the LEDs 41 enters the light guide plate 43 through only one side surface of the light guide plate 43. The LEDs 41 are disposed at one of the ends in the long-side direction of the backlight device 40.

The LED 41 (light source) has an LED chip sealed with a sealing material. The LED chip emits a single color of blue, for example, and the sealing material contains phosphors (yellow, green, and red phosphors) in a dispersed state. Thus, the LED 41 emits white light as a whole. The configuration of the LED 41 is not limited to this configuration and may be suitably changed. The LED board 42 is formed of a flexible insulating film (sheet). The LEDs 41 are disposed with a predetermined distance therebetween on the LED board 42. The distance between the LEDs 41 is equal in this embodiment but is not limited to equal.

The light guide plate 43 is formed of a substantially transparent synthetic resin (an acrylic resin such as PMMA and polycarbonate, for example) and has a refractive index sufficiently higher than that of air. As illustrated in FIG. 1, the light guide plate 43 has a vertically long rectangular shape as the liquid crystal panel 20. As illustrated in FIG. 2, one of four side surfaces of the light guide plate 43 is a light input surface 49 facing light emitting surfaces 48 of the LEDs 41. The light input surface 49 extends linearly along the array of the LEDs 41 (FIG. 1). As illustrated in FIG. 2, one of the major surfaces of the light guide plate 43 that faces the front side (liquid crystal panel 20) is a light output surface 50. The light from the LEDs 41 enters the light guide plate 43 through the light input surface 49. The light travels through the light guide plate 43 and then exits through the light output surface 50 toward the optical sheet 51.

The optical sheet 51 includes a microlens sheet 52 that provides the light with isotropic light focusing effect, a prism sheet 53 that provides the light with anisotropic light focusing effect, and a reflective polarizing sheet 54 that polarizes and reflects the light. The microlens sheet 52, the prism sheet 53, and the reflective polarizing sheet 54 are stacked on top of another in this order from the bottom. The kind or the number of sheets included in the optical sheet 51 may be suitably changed. The light reflection sheet 46 has high light reflectance and reflects the light that has leaked from the light guide plate 43 through the surface opposite the light output surface 50 to the front side. The frame 47 has a white surface and is formed of a synthetic resin (polycarbonate, for example). The frame 47 collectively surrounds the LEDs 41 and the light guide plate 43. The frame 47 is fixed to the liquid crystal panel 20 by a fixing tape 55 having light blocking effect. The liquid crystal panel 20 overlaps the light output surface 50 of the light guide plate 43 and provides an image by using the light from the light output surface 50.

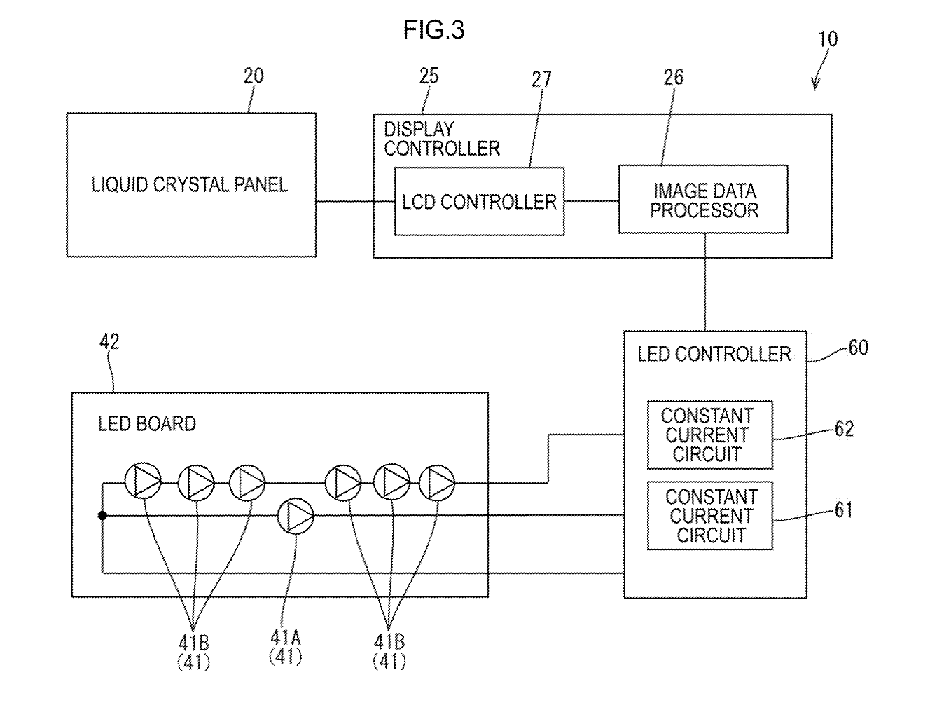

Next, controllers of the liquid crystal panel 20 and the backlight device 40 are described. As indicated in FIG. 3, the liquid crystal display device 10 according to the embodiment includes a display controller 25 that controls the liquid crystal panel 20 to display an image in the display area A1 and an LED controller 60 (light source controller) that controls on and off states of the LEDs 41. The display controller 25 includes an image data processor 26 that generates image signals based on the image data and an LCD controller 27 that controls the driver (not illustrated) of the liquid crystal panel 20 based on the generated image signals. With this configuration, the display controller 25 is able to drive the switching device on the array substrate 23 by controlling the driver, and thus the orientation of liquid crystals of the liquid crystal panel 20 is controlled for each pixel. Thus, a predetermined image is displayed in the display area A1 of the liquid crystal panel 20. The image data, which is the base of the image signals, is supplied from a device (not illustrated) connected to the display controller 25 (a memory that stores the image data, or a tuner configured to receive the image data, for example) to the display controller 25.

The LED controller 60 includes constant current circuits 61 and 62 that supply a constant current to the LEDs 41. The middle LED 41 in the array of the LEDs 41 is connected to the constant current circuit 61 at the cathode. In the following description, the LED 41 connected to the constant current circuit 61 is referred to as the LED 41A (at least one of the light sources) such that the LED 41A is distinguished from the other LEDs 41. In this embodiment, the total number of the LEDs 41 is an odd number. However, the total number may be an even number. In such a case, two middle LEDs 41 may be the LEDs 41A, for example.

The LEDs 41 except for the LED 41A are connected to the constant current circuit 62. In the following description, the LEDs 41 that are connected to the constant current circuit 62 are referred to as the LEDs 41B (the other light sources) such that the LEDs 41B are distinguished from the LED 41A. The LEDs 41B (six LEDs 41B in this embodiment) are connected in series. The LED 41A and the LEDs 41B are connected at the anodes to a common point.

The LED controller 60 is configured to dim the LEDs 41. Examples of the dimming technique for the LEDs 41 by the LED controller 60 include PWM dimming and constant-current dimming. PWM dimming involves varying the time ratio (duty cycle) between ON time period and OFF time period of the circuit while applying a constant current to the LEDs 41. Constant-current dimming involves controlling a value of current flowing through the LEDs 41. Furthermore, the LED controller 60 is configured to switch between a first lighting mode in which all the LEDs 41 are turned on and a second lighting mode in which the LED 41A is turned on and the LEDs 41B are turned off. Specifically described, the LED controller 60 is configured to turn on and off each of the constant current circuits 61 and 62. The LED controller 60 turns on both the constant current circuits 61 and 62 to allow the LEDs 41 to be in the first lighting mode, and turns on the constant current circuit 61 and turns off the constant current circuit 62 to allow the LEDs 41 to be in the second lighting mode.

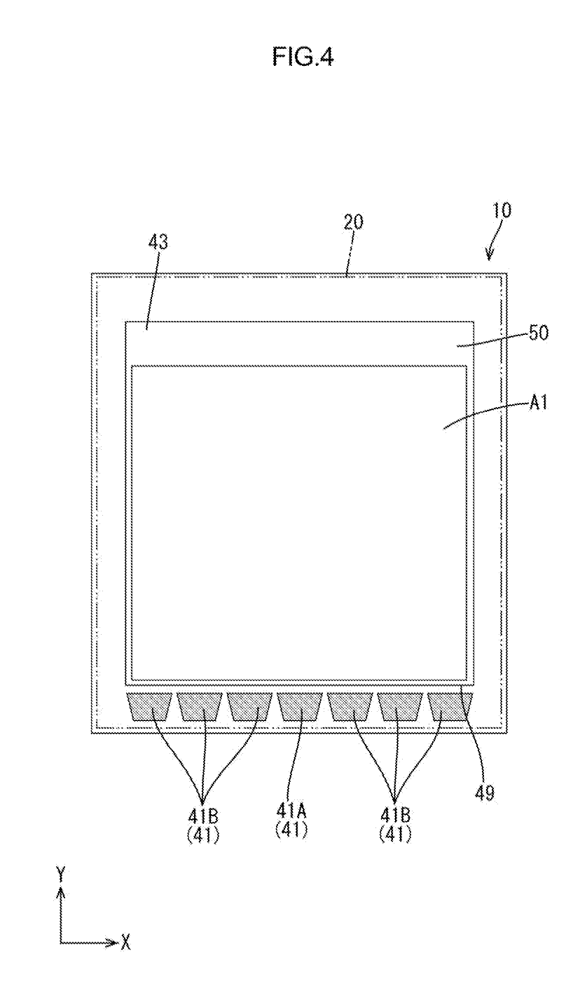

The image data processor 26 of the display controller 25 and the LED controller 60 are electrically connected to each other. With this configuration, the LED controller 60 is able to switch between the first lighting mode and the second lighting mode based on the image signals generated by the image data processor 26. In this embodiment, the first lighting mode and the second lighting mode are switched depending on the type of the image to be displayed in the display area A1. In the first lighting mode, the LED controller 60 turns on all the LEDs 41. Thus, as illustrated in FIG. 4, in the first lighting mode, the brightness is substantially uniform over the entire light output surface 50 or the display area A1.

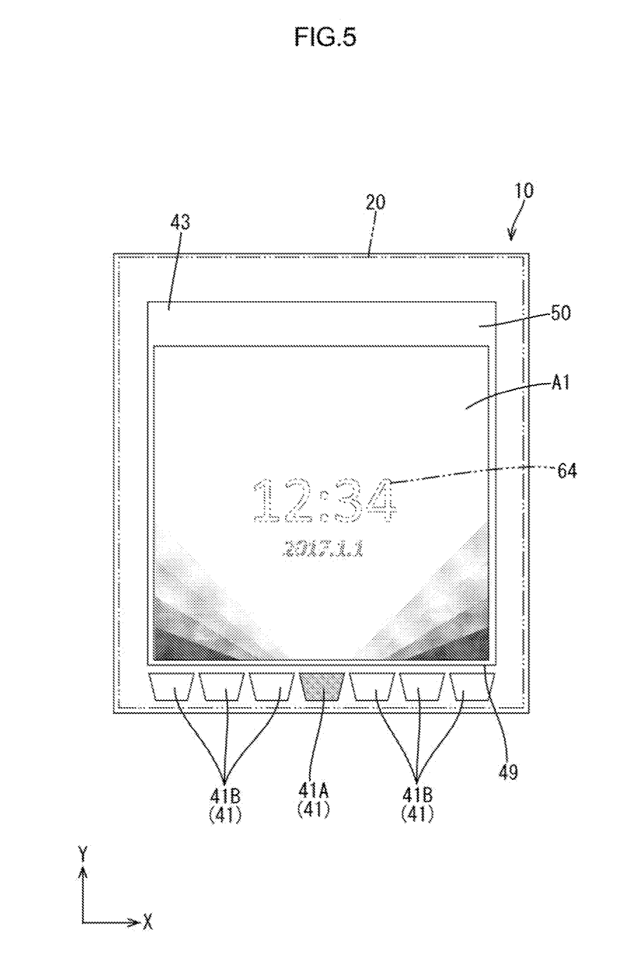

In the second lighting mode, the LED controller 60 turns on only the LED 41A. The light guide plate 43 is designed to have uniform brightness over the entire light output surface 50 with all the LEDs 41 (seven LEDs 41 in this embodiment) being turned on. Thus, as illustrated in FIG. 5, in the second lighting mode, the portions of the light output surface 50 corresponding to the LEDs 41B have lower brightness, resulting in uneven brightness. The output light from the LED 41A radiates, and thus the brightness unevenness is less likely to be seen at a position far away from the LED 41A and is likely to be seen at a position near the LEDs 41A. FIG. 4 and FIG. 5 indicate the brightness distribution (corresponding to the brightness distribution on the light output surface 50) on the display area A1 providing a white display.

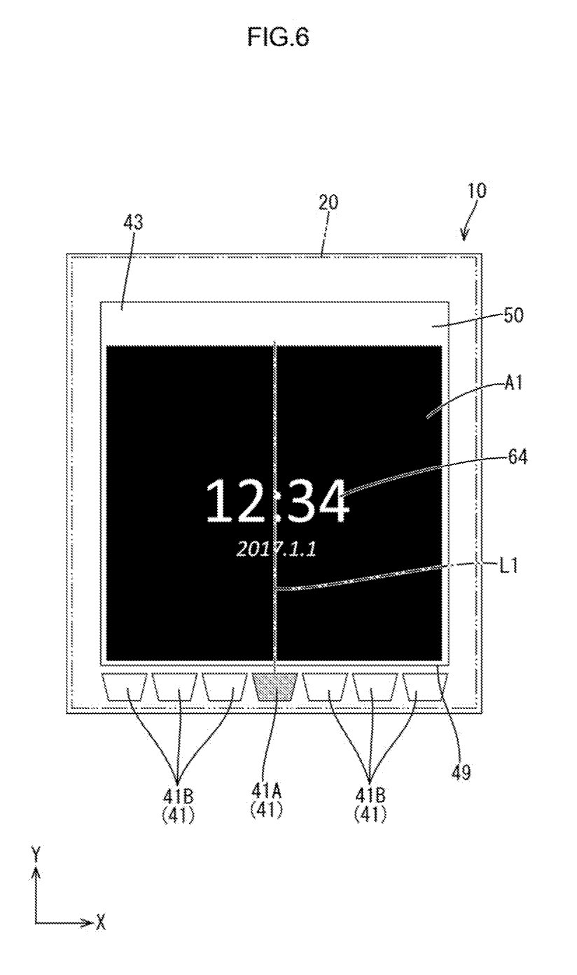

To solve the problem, in this embodiment, an image is displayed in the entire display area A1 when the LEDs 41 are in the first lighting mode and an image is displayed in a portion of the display area A1 when the LEDs 41 are in the second lighting mode. FIG. 6 illustrates a “time display” image 64 on a standby screen of a smartphone as an example of an image displayed in the second lighting mode. The image 64 is displayed in the middle of the display area A1 in the Y-axis and X-axis directions, for example. In other words, in the second lighting mode, the display controller 25 allows the area around the image 64 to provide a black display, particularly, the end portion of the display area A1 adjacent to the LEDs 41 (portion likely to have uneven brightness in the second lighting mode) to provide a black display. The image 64 in the display area A1 overlaps the optical axis L1 of the LED 41A in plan view. The term “black display” used herein refers to a display with the minimum gray level but is not limited to a display with the minimum gray level and may be a display with a low gray level that is recognizable as a black display. The LED 41A is positioned such that the optical axis L1 thereof overlaps the center of the display area A1 in the X-axis direction, for example.

Next, the advantages of the embodiment are described. In this embodiment, the second lighting mode allows only the LED 41A to be turned on, consuming less power than the first lighting mode. However, when only the LED 41A is turned on, the light output surface 50 of the light guide plate 43 is relatively dark at the portions corresponding to the LEDs 41B that are not turned on. This leads to uneven brightness. The output light radiates from the LED 41A, and thus the uneven brightness is likely to be seen in the display area A1 at the portion close to the LEDs 41. To solve the problem, when the LEDs 41 are in the second lighting mode, the display controller 25 provides a black display in the display area A1 of the liquid crystal panel 20 over at least the end portion adjacent to the LEDs 41. This reduces the power consumption and also reduces the uneven brightness in the light output surface 50, which is caused when only the LED 41A is turned on.

When the LEDs 41 are in the second lighting mode, the display controller 25 allows the image 64 to be displayed on at least a portion of the display area A1 overlapping the optical axis L1 of the LED 41A in plan view. Since the image 64 is displayed on the portion of the display area A1 overlapping the optical axis L1 of the LED 41A, the image 64 is not displayed on a portion of the display area A1 outside the light application area of the LED 41A, reliably reducing the uneven brightness of the image 64.

The LED 41A, which is turned on in the second lighting mode, is the middle LED 41 in an array of LEDs 41. Since the light radiates from the LED 41, light from the middle LED 41A of the LEDs 41 exits the light guide plate 43 through a large area of the light output surface 50 compared with light from the endmost LED 41. This allows, in the second lighting mode, an image to be displayed in a larger area of the display area A1, because the light exits through a larger area of the light output surface 50.

The number of LEDs 41B of the LEDs 41 is plural and the LEDs 41B are connected in series. If the LEDs 41B are connected in parallel, the current passing through the LEDs 41B may differ depending on individual variability, leading to uneven brightness. The LEDs 41B connected in series reduces the possibility that the LEDs 41B will have uneven brightness.

### Other Embodiments

The technology disclosed herein is not limited to the embodiment described above and with reference to the drawings. The following embodiments are included in the technical scope, for example.

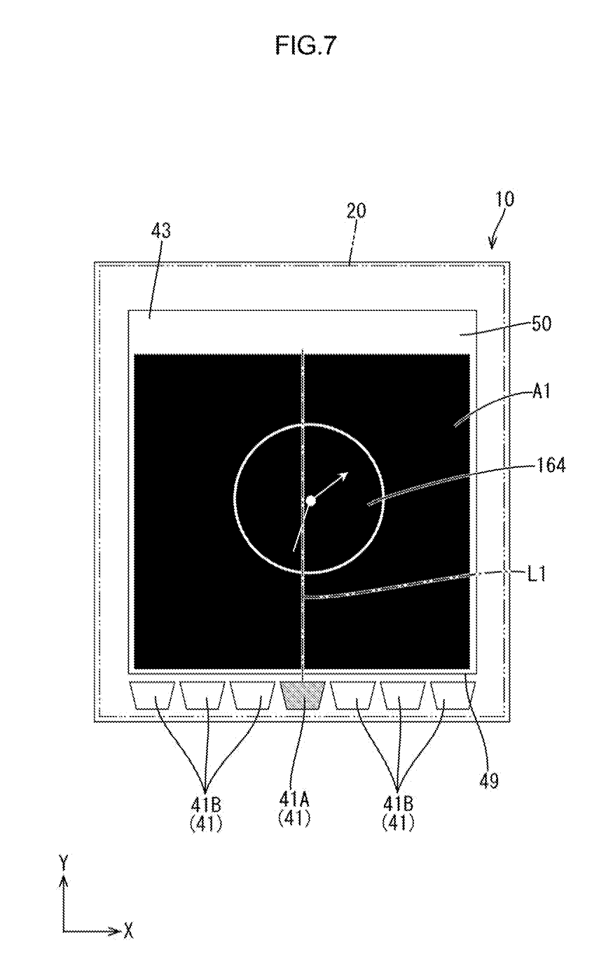

(1) The image displayed in the display area A1 in the second lighting mode is not limited to the image described in the above-described embodiment and may be suitably changed. For examples, as illustrated in FIG. 7, in the second lighting mode, an image 164 of a clock indicating time may be displayed. An image displayed in the second lighting mode may be an image that informs the user that a message is received, for example. In the second lighting mode, at least the end portion of the display area A1 adjacent to the LEDs 41 is required to provide a black display, and the position of the image and the display area may be suitably changed. For example, in the second lighting mode, the image may be concentrated in an area of the display area A1 away from the LEDs 41.

(2) The number of the LEDs 41 is not limited to that in the embodiment and may be suitably determined. The numbers of the LEDs 41A and the LEDs 41B may also be suitably determined. For example, multiple LEDs 41A may be turned on in the second lighting mode. When the number of LEDs 41A is smaller than the number of LEDs 41B, the power consumption in the second lighting mode is reduced.

(3) In the above embodiment, the position of the LED 41A in the X-axis direction corresponds to the center of the display area A1, but the position of the LED 41A is not limited to this position.

(4) In the above embodiment, a liquid crystal panel is described as an example of the display panel but is not limited the display panel. The present technology is applicable to other display panels such as Microelectromechanical systems (MEMS) display panel.

(5) In the above embodiment, the image displayed in the second lighting mode overlaps the optical axis L1 of the LED 41A, but the position of the image is not limited to this position.

(6) The position in the X-axis direction of the LED 41 that is turned on in the second lighting mode is not limited to that in the above embodiment. The position may be suitably determined depending on the position of the image to be displayed. For example, when an image is displayed on one end portion of the display area A1 in the X-axis direction, the LED 41 located adjacent to the one end of the display area A1 in the X-axis direction may be turned on in the second lighting mode.

(7) The electrical configuration of the liquid crystal display device 10 is not limited to that indicated by the block diagram in FIG. 3 and may be suitably designed. Any electrical configuration that is able to provide a black display in the display area A1 over an end portion adjacent to the LEDs 41 when the LEDs 41 are in the second lighting mode may be employed.

(8) In the above embodiment, the LED controller 60 switches between the first lighting mode and the second lighting mode in accordance with image signals generated by the image data processor 26, but the configuration for switching is not limited thereto. The LED controller 60 may send a signal to inform that the lighting mode is switched to the second lighting mode to the display controller 25 and the display controller 25 may provide a black display in the display area A1 over the end portion adjacent to the LEDs 41 based on the signal.

1. A display device comprising:
a plurality of light sources spaced apart from each other;
a light guide plate having a light input surface that faces the plurality of light sources to receive light from the plurality of light sources and a light output surface through which the light exits, the light input surface and the light output surface being, respectively, a side surface and a plate surface of the light guide plate,
a display panel overlapping the light output surface and configured to display an image by using light from the light output surface;
a light source controller configured to switch between a first lighting mode and a second lighting mode, the first lighting mode allowing the plurality of light sources to be turned on, the second lighting mode allowing at least one of the plurality of light sources to be turned on and another one of the plurality of light sources to be turned off; and
a display controller configured to provide a black display in an end portion of a display area of the display panel, the end portion being adjacent to the plurality of light sources in the second lighting mode.

2. The display device according to claim 1, wherein in the second lighting mode, the display controller is configured to display the image in a portion of the display area, the portion overlapping an optical axis of the light emitted by the at least one of the light sources in a plan view.

3. The display device according to claim 1, wherein the at least one of the plurality of light sources is a middle light source in an array of the plurality of light sources.

4. The display device according to claim 1, wherein the other one of the plurality of light sources includes two or more light sources, and
the two or more of the plurality of light sources are connected in series.
